(19) United States
(12) Patent Application Publication
(10) Pub. No.: US 2026/0258875 A1
(43) Pub. Date: Sep. 3, 2026

(54) DEVICE FOR HOLDING A SLIDING DOOR ARRANGEMENT WITH AN EXTERIOR SLIDING FOR A MOTOR VEHICLE

(71) Applicant: VERNET, OLLAINVILLE (FR)

(72) Inventor: Julien Guillaume GAUTIER GRAINDORGE, MONTIGNY LE BRETONNEUX (FR)

(21) Appl. No.: 18/879,567

(22) PCT Filed: Jun. 28, 2023
(86) PCT No.: PCT/EP2023/067670

§ 371 Date: Dec. 27, 2024

(30) Foreign Application Priority Data
Jun. 29, 2022 (FR) FR2206539

(51) Int. Cl. F16K 11/085; F16K 31/04

(52) U.S. Cl. CPC F16K 11/085; F16K 31/041

(57) ABSTRACT

A valve includes a housing defining an internal volume through which fluid passes. An electric pump, in a first sub-volume, has a suction opening into an inlet of the housing, and with a discharge opening into a passage of the internal volume. A valve disk, in a second sub-volume of the internal volume, is rotatable about a valve disk axis to control the opening-closing of outlets of the housing, the first and second sub-volumes being connected directly to each other by the passage which is delimited by the housing by opening out into the second sub-volume along a direction radial to the valve disk axis. An electric actuator has a driving output rotatable about an actuator axis. A mechanical transmission system connects the disk valve to the driving outlet such that rotation of the driving outlet rotates the valve disk. An electronic device controls the pump and the actuator.

The present invention relates to a fluid-dispensing motorized valve.

The invention is particularly focused on valves for circuits for the circulation of fluids, in particular coolants, on-board vehicles with internal combustion, electric, hydrogen or hybrid engines. Such a valve comprises a valve disk, which is movably mounted in a housing of the valve to regulate a flow of fluid through the housing between an inlet and outlets of the housing. The valve disk is driven in motion by an electric actuator, integrated into the valve and with a rotary motor output. The invention is more specifically concerned with valves the valve disk of which rotates about an axis with respect to the housing. The fluid flows through the valve by driving same into the circulation circuit to which the valve belongs, under the effect of a pump, typically an electric pump.

In practice, hoses connect the valve to the pump. More particularly, a hose can connect the pump discharge to the inlet of the valve. In addition, the power supply to the actuator of the valve and of the pump requires two separate electrical harnesses, each extending from an external power source. Significant bulk and hence a substantial weight result therefrom, with associated costs, as well as risks of leaks and head losses at the hoses.

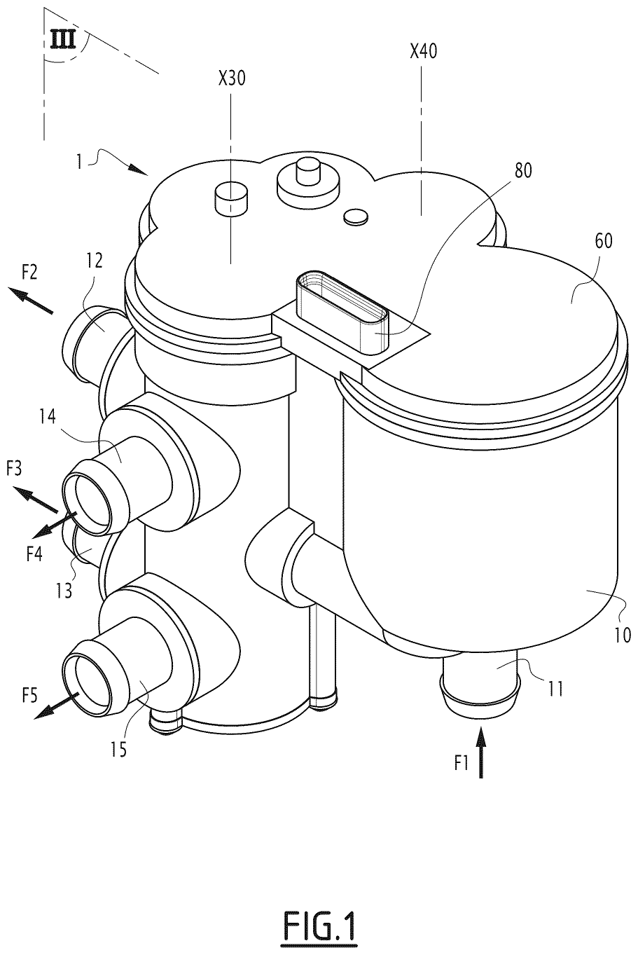

US 2018/347448 thus discloses a valve for dispensing a coolant to an engine of an automobile. In a first embodiment which is illustrated in FIGS. 1 to 7 of US 2018/347448, the valve includes a housing resulting from the assembly of casings, one of which is cylindrical and coaxially receives a rotary valve disk which controls the opening/closing of three connection ports which open into a line feeding a heat exchanger, into a line feeding an oil cooler, and into a line feeding a radiator, respectively. The above-mentioned cylindrical casing is supplied with fluid from a motor, upstream of which the fluid is driven under pressure by a pump. The fluid supply of the cylindrical casing is provided along the axis of the cylindrical casing, via an axial end opening of the latter. In a second embodiment of US 2018/347448, illustrated in FIG. 9, the pump is placed directly upstream of the valve and it is envisaged, without details of implementation, that the pump and the valve can be formed as a single integrated unit.

The goal of the present invention is to propose a motorized valve which is more compact and has higher performance.

To this end, the subject matter of the invention is a fluid-dispensing motorized valve, as defined in claim 1.

One of the fundamental ideas of the invention is to integrate a fluid drive pump into the valve, so as to form a module having a single housing and a single connector for connection to an external source of electrical power. To this end, the internal volume of the housing of the valve according to the invention, wherein the fluid is provided to flow between an inlet and at least two outlets of the housing, is subdivided into two sub-volumes which are connected directly to each other by a passage delimited by the housing: the pump is mounted in the first sub-volume so as to suck the fluid at the inlet of the housing and to deliver the fluid into the aforementioned passage, while the valve disk is mounted rotatably in the second sub-volume so as to send the fluid from the aforementioned passage toward one or a plurality of the least two outlets, thereby controlling the opening-closing of the latter. The aforementioned passage avoids the need for a hose, eliminating the risk of leaks, reducing the head-loss and saving weight, and assembly time and gaining in compactness. The invention also provides for the “pooling” of the electrical means controlling the pump and the actuator, in the form of an electronic device which is connected to the single connector supported externally by the housing. Here again, there is a savings in weight and reliability, in particular by limiting the number of electrical harnesses and by facilitating the corresponding assembly of the valve according to the invention. The arrangement of the pump, of the valve disk and of the actuator can advantageously be optimized to gain even more compactness and performance, as discussed in detail thereafter.

Advantageous additional features of the valve according to the invention are stated in the other claims.

The invention will be better understood upon reading the following description, given only as an example and making reference to the drawings, wherein:

FIG. 1 is a perspective view of a valve according to the invention;

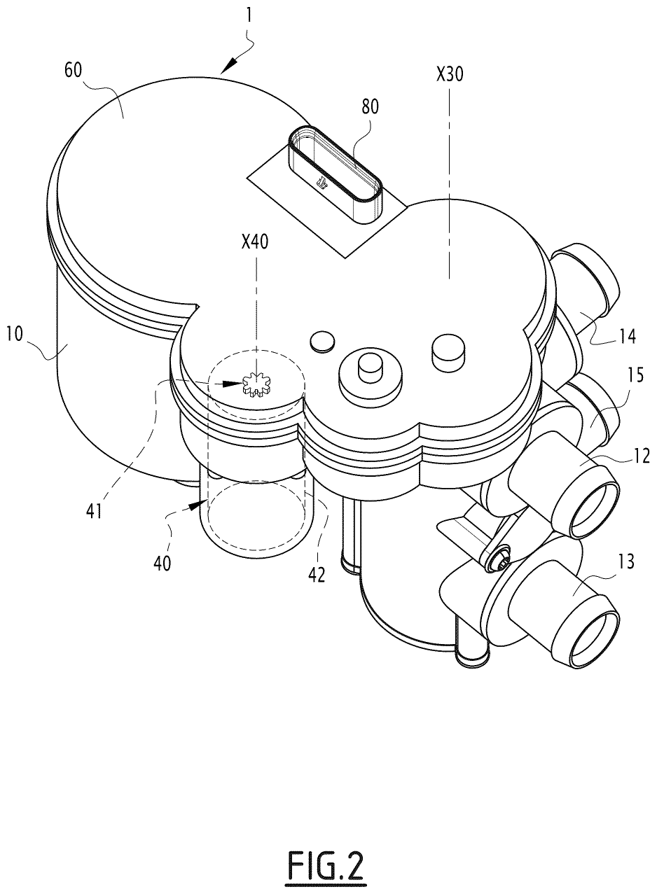

FIG. 2 is a view similar to FIG. 1, from a different angle of observation;

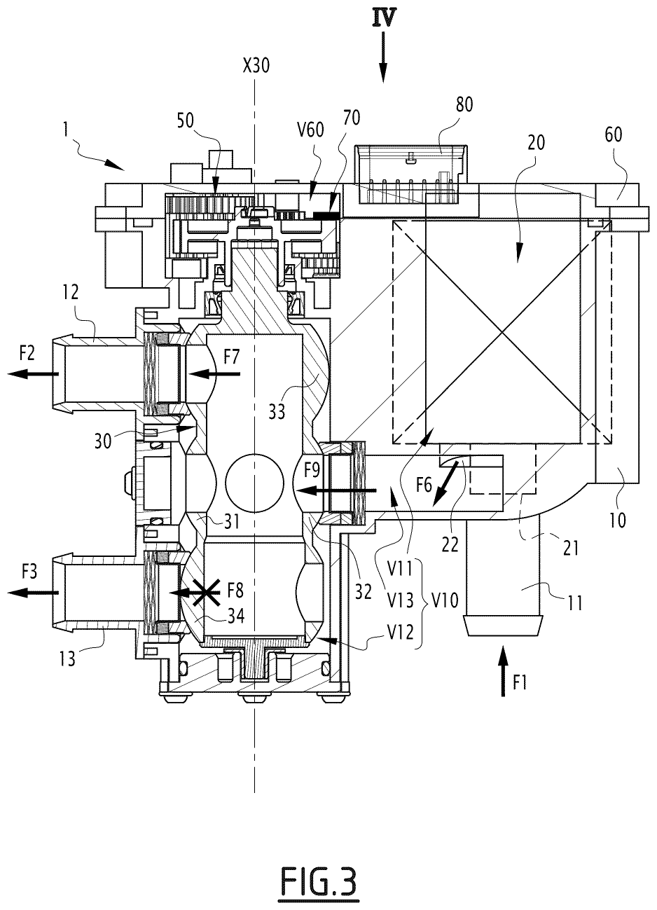

FIG. 3 is a section along the plane 3 shown in FIG. 1; and

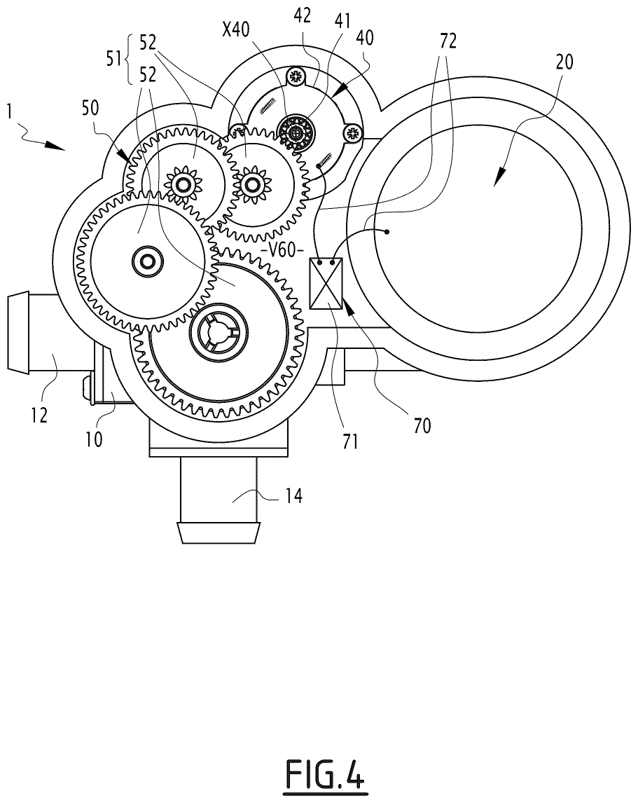

FIG. 4 is an elevation view, along the arrow IV in FIG. 3, after the removal of a cover of the valve.

FIGS. 1 to 4 show a fluid-dispensing motorized valve with the reference 1. The valve 1 is suitable for being integrated into a circuit for the circulation of a fluid, in particular a coolant. The valve 1 is e.g. used in a cooling circuit of a motorization of a vehicle, the motorization being an internal combustion, electric, hydrogen or hybrid engine.

The valve 1 includes a housing 10 through which the fluid to be regulated/dispensed by the valve 1 is provided to flow. To this end, as can be seen clearly in FIG. 3, the housing 10 fixedly delimits an internal volume V10 through which the fluid passes through the housing and which opens onto the outside of the housing via an inlet 11 and outlets, herein four, referenced 12, 13, 14 and 15, respectively. The inlet 11 can communicate with the outlets 12 to 15 through the housing 10 via the internal volume V10, the effective communication between the inlet 11 and one or a plurality of the outlets 12 to 15 being operated by the rest of the valve 1, as discussed in detail thereafter. In service, the fluid enters the internal volume V10 via the inlet 11, as indicated schematically by the arrow F1 in the figures, and the fluid leaves the internal volume V10 via the outlets 12 to 15, as indicated schematically in the figures by the respective arrows F2, F3, F4 and F5.

The embodiment of the housing 10 is not limiting as long as the housing consists of a body which is sufficiently rigid to fixedly delimit the internal volume V10. In practice, the body of the housing 10 may consist of a plurality of parts assembled fixedly to one another, by any appropriate means.

In all cases, the internal volume V10 is, as clearly visible in FIG. 3, divided between:
a sub-volume V11 into which the inlet 11 opens out;
a sub-volume V12 into which the outlets 12 to 15 open out; and
a passage V13 that connects the sub-volumes V11 and V12 directly to each other.

Specific features relating to sub-volumes V11 and V12 and to passage V13 will be given thereafter.

The valve 1 further includes a pump 20 for driving the fluid through the housing 10 via the internal volume V10. As shown in FIGS. 3 and 4 only schematically, the pump 20 is supported by the housing 10, being arranged in the sub-volume V11. The pump 20 is provided with a suction 21, i.e. an orifice through which the fluid pumped by the pump 20 flows toward the interior of the pump and thereby enters the body of the pump 20, and with an outlet 22, i.e. an orifice through which the fluid pumped by the pump 20 flows toward the exterior of the pump and thereby leaves the body of the pump. In the assembled state of the valve 1, the suction 21 opens out into the inlet 11 so that all the fluid entering the internal volume, via the inlet 11, directly enters the inlet of the pump 20; the outlet 22 opens out into the passage V13 so that all the fluid discharged by the pump 20 is directly sent to the inlet of the passage V13, as indicated schematically by the arrow F6 in FIG. 3.

The pump 20 is electric, i.e. is driven by an electric motor, integrated into the pump. In practice, multiple embodiments of electric pumps can be envisaged for the pump 20, without such aspect being limiting.

The valve 1 further includes a valve disk 30 which is supported by the housing 10, being arranged in the sub-volume V12 and being movable therein in rotation about a valve disk axis X30 with respect to the housing 10. The valve disk 30 makes it possible, due to the rotational mobility thereof about the valve disk axis X30, to regulate the flow of the fluid through the housing 10 by controlling the opening-closing of the outlets 12 to 15 of the housing 10. In the assembled state of the valve 1, the valve disk 30 cooperates by leak-tight contact with seats, which are associated with the outlets 12 to 15, respectively, and which are supported by the housing 10, so that for each seat, the valve disk 30 is provided, depending on the position of the valve disk 30 around the valve disk axis X30, to:
either let the fluid to pass through the seat so that the fluid flows from the sub-volume V12 to the outlet associated with the seat, which is equivalent to opening the outlet associated with the seat, as illustrated schematically by arrow F7 in FIG. 3 for the outlet 12;
or prevent the fluid from passing through the seat from the sub-volume V12 to reach the outlet associated with the seat, which is equivalent to closing the outlet associated with the seat, as illustrated by the crossed-out arrow F8 in FIG. 3 for the outlet 13.

At least in each of the positions of the valve disk 30 around the valve disk axis X30, which control the opening of at least one of the outlets 12 to 15, the valve disk 30 allows the fluid to enter the sub-volume V12 from the passage V13, as indicated schematically by the arrow F9 in FIG. 3, where appropriate by cooperating in a leak-tight manner with a dedicated seat which is supported by the housing 10 at the opening out of the passage V13 into the sub-volume V12.

In the embodiment considered in the figures, the valve disk 30 includes an overall tubular body 31, which is centered on the valve disk axis X30. On the outer lateral face thereof, the tubular body 31 fixedly supports spherical reliefs, which are centered on the valve disk axis X30 and which are distributed along the valve disk axis so as to cooperate by mating shapes with the aforementioned seats which are thus, herein, provided spherical: in the example illustrated in the figures, the spherical reliefs are provided in three pieces, having the references 32, 33 and 34. At the spherical relief 32, which is located herein between the spherical reliefs 33 and 34 along the valve disk axis X30, the lateral wall of the tubular body 31 is traversed, radially right through, by four openings, which are distributed regularly about the valve disk axis X30 and which can each be aligned with the opening of the passage V13 in the sub-volume V12 when the valve disk occupies a corresponding angular position among four angular positions of the valve disk 30, spaced apart by 90° from one another. Thereby, when the valve disk 30 is successively driven in rotation about the valve disk axis X30 from one of the four aforementioned angular positions to the other, the four openings of the spherical relief 32, three of which are visible in FIG. 3, are successively aligned with the passage V13, with the spherical relief 32 in leak-tight abutment against the seat provided at the opening out of the passage V13 into the sub-volume V12. At the spherical relief 33, the lateral wall of the tubular body 31 is traversed radially right through by two openings, which are distributed around the valve disk axis X30 and one of which is aligned with the opening out of the outlet 12 into the sub-volume V12 when the valve disk 30 occupies a first of the four aforementioned angular positions whereas the other of the two openings is aligned with the opening out of the outlet 14 in the sub-volume V12 when the valve disk occupies the second of the four aforementioned angular positions, with a sealed abutment of the spherical relief 33 against the seats associated with the outlets 12 and 14, respectively. At the spherical relief 34, the lateral wall of the tubular body 31 is traversed radially right through by two openings, which are distributed around the valve disk axis X30 and one of which is aligned with the opening out of the outlet 13 into the sub-volume V12 when the valve disk 30 occupies a third of the four aforementioned angular positions whereas the other of the two openings is aligned with the opening out of the outlet 15 in the sub-volume V12 when the valve disk 30 occupies the fourth of the four aforementioned angular positions, with a leak-tight abutment of the spherical relief 34 against the seats associated with the outlets 13 and 15, respectively. It should be understood that the valve disk 30 sends, therethrough, i.e. via the internal bore thereof, all the fluid leaving the passage V13 into only one of the four outlets 12 to 15, which is determined by the angular position of the valve disk 30 around the valve disk axis X30:
when the valve disk 30 is in the first aforementioned angular position, the valve disk 30 thereby sends all the fluid leaving the passage V13 exclusively into the outlet 12, the first angular position being illustrated in FIG. 3;
when the valve disk is in the second angular position, the valve disk 30 sends all the fluid leaving the passage V13 exclusively into the outlet 14;
when the valve disk 30 is in the third angular position, the valve disk 30 sends all the fluid leaving the passage V13 exclusively into the outlet 13; and
when the valve disk 30 is in the fourth angular position, the valve disk 30 sends all the fluid leaving the passage V13 into the outlet 15.

In other words, the valve disk 30 selectively dispenses the fluid entering the internal volume V10 of the housing 10 selectively into one of the four outlets 12 to 15.

In practice, embodiments other than the embodiment discussed in detail hereinbelow can be envisaged for the valve disk 30, such as a vane valve disk.

In all cases, according to an advantageous arrangement which is implemented in the figures and which limits the overall size of the valve 1, the valve disk 30 is arranged opposite the pump 20 along a direction radial to the valve disk axis X30. In other words, the valve disk 30 and the pump 20 are arranged overall side by side along a direction radial to the valve disk axis X30, which, among other things, reduces the extent of the passage V13 between the ends of the latter which open out into the outlet 22 of the pump 20 and into the sub-volume V12, respectively.

For the purpose of limiting head-losses, the passage V13 opens out into the sub-volume V12 along a direction radial to the valve disk axis X30, or even opens out into the sub-volume V12 exclusively radially to the valve disk axis X30. Preferably, the passage V13 extends along the radial direction throughout the extent thereof between the ends thereof opening out into the delivery 22 of the pump 20 and into the sub-volume V12, respectively. In practice, as can be seen clearly in FIG. 3, the opening out of the passage V13 into the sub-volume V12 is advantageously situated, along the valve disk axis X30, both between and at a distance from the opposite axial ends of the sub-volume V12. Head-losses at passage V13 are thereby further limited.

In order to control the displacement of the valve disk 30, in particular between the four aforementioned angular positions thereof, the valve 1 includes an actuator 40. The actuator 40 is electrical in the sense that the actuator is designed to transform the electrical power supplying same into a mechanical driving power, applied to the outside of the actuator 40 by a driving output 41 of the latter, which is rotatable about a geometric axis. In the assembled state of the valve 1, the actuator 40 is supported by the housing 10 so that the driving output 41 thereof is rotatable about an actuator axis X40 with respect to the housing 10. As shown schematically in FIGS. 2 and 4, the actuator 40 typically comprises an external housing 42, inside which electromechanical components of the actuator are arranged, which convert the electrical power into a driving power, the driving output 41 extending through the external housing 42. The driving output 41 is provided herein in the form of a toothed shaft centered on the actuator axis X40, with the proviso that other embodiments can be envisaged for the driving output 41. The outer housing 42 is fixedly secured to the housing 10 by any appropriate means, in particular in a dedicated housing of the latter, distinct from the internal volume V10.

According to an advantageous arrangement, which is implemented in the example illustrated in the figures and which contributes to the compactness of the valve 1, the actuator axis X40 is parallel to the valve disk axis X30. Moreover, the actuator 40 is arranged both opposite the pump 20 along a direction radial to the actuator axis X40 and opposite the valve disk 30 along a direction radial to the actuator axis X40: in this way, as clearly visible in FIG. 2, the actuator 40 is located side by side, along directions radial to the actuator axis X40 thereof, of the pump 20 and of the valve disk 30, occupying at least partially a free space separating the latter, which further limits the overall size of the valve 1.

In order to transmit the driving power applied by the driving output 41 of the actuator 40 to the valve disk 30, the valve 1 includes a mechanical transmission system 50. As shown in FIGS. 3 and 4, the transmission system 50 is supported by the housing 10 and mechanically connects the valve disk 30, herein the tubular body 31, to the driving outlet 41 in such a way that a rotation of the driving outlet 41 about the actuator axis X40 drives the valve disk 30 in rotation about the valve disk axis X30.

In the embodiment considered in the figures, the transmission system 50 includes a gear 51 consisting of a plurality of toothed wheels 52 which are herein four. The toothed wheels 52 mesh successively with each other, being rotatable with respect to the housing 10 about respective axes of rotation which are parallel to the valve disk axis X30. A first of the toothed wheels 52 is engaged with the driving output 41, herein with the toothed shaft formed by the latter, while the last of the toothed wheels 52 is engaged with the valve disk 30, herein with an axial end of the tubular body 31 thereof, for the purpose of driving the valve disk 30 in rotation about the valve disk axis X30. The gear 51, the specificities of which are not limiting, makes it possible to multiply the movement transmitted from the driving output 41 to the valve disk 30. Of course, embodiments other than the gear 51 can be envisaged for the transmission system 50.

In all cases, according to an advantageous arrangement aimed at improving the design and performance of the valve 1, the transmission system 50 is, as shown in FIGS. 3 and 4, arranged inside a sealed compartment V60, which is delimited jointly by the housing 10 and by a cover 60 directly mounted on the housing 10. The compartment V60 is completely separated from the internal volume V10, thereby forming a region of the valve 1, which is leak-tight with respect to the fluid circulating through the valve 1. The cover 60, which is clearly visible in FIGS. 1 to 3 but which is removed from the rest of the valve 1 in FIG. 4, is rigidly attached in a leak-tight manner to the body of the housing 10, by any appropriate means, in particular by removable rigid attachment means, so as to facilitate the assembly and maintenance of the elements placed inside the compartment V60, including the transmission system 50. The cover 60 is advantageously arranged at one end of the body of the housing 10 along the valve disk axis X30: the pump 20 and the valve disk 30, as well as, herein, the actuator 40, are arranged on the same axial side of the compartment V60, which makes it possible to limit the overall size of the valve 1.

The valve 1 further includes an electronic device 70 for controlling both the actuation of the pump 20 and the actuation of the actuator 40. The electronic device 70 is supported, directly or indirectly, by the housing 10, being advantageously arranged in the compartment V60, as clearly visible in FIGS. 3 and 4 in which the electronic device 70 is shown only schematically. In all cases, the electronic device 70 is electrically connected to the pump 20 and to the actuator 40 for the purpose of controlling the latter and transporting current to the latter to feed same with electricity. To this end, the electronic device 70 typically includes a printed circuit 71, an insulating support of which, such as a board, is fastened to the housing 10, and conductors 72 connecting electronic and/or electrotechnical components, supported by the insulating support, to the pump 20 and to the actuator 40, as shown schematically in FIG. 4. In practice, the insulating support of the printed circuit 71 is fastened to the housing 10 either directly or indirectly, in particular by means of the cover 60. In all cases, the electronic and/or electrotechnical components of the printed circuit 71 make it possible to send electrical control and supply signals to the pump 20 and to the actuator 40: such aspect being known per se, same will not be described in detail thereafter herein.

In addition, the electronic device 70 is electrically connected to a single connector 80 for connection to an external source of electrical power supply. The external source electrical power supply is external to the valve 1 and is not shown in the figures, the embodiment thereof not being limiting: this external source of electrical power supply comprises e.g. a battery which is mounted on-board the vehicle to which the valve 1 belongs. In practice, the electrical connection between the connector 80 and the external electrical supply source is ensured by a single harness, which is known per se and which is not shown in the figures; the harness can have multiple embodiments, by integrating in particular, in addition to one or a plurality of lines suitable for conducting electricity from the external source of electrical supply, one or a plurality of lines connected to a control and/or supervision unit, such as an on-board computer. In all cases, the connector 80 is the only member of the valve 1, allowing the latter to be connected for the purposes of controlling and supplying electricity to both the pump 20 and the actuator 40.

As can be seen clearly in FIGS. 2 to 3, the connector 80 is supported externally by the housing 10 so as to enable same to be connected to the aforementioned harness from outside the valve 1. In practice, the connector 80 is thereby supported by the housing 10 either directly or indirectly, in particular by the cover 60 as in the embodiment envisaged in the figures.

Finally, various arrangements and variants of the valve 1 described up to now are moreover conceivable:
rather than the actuator axis X40 being parallel to the valve disk axis X30, the actuator axis X40 extends transversely to the valve disk axis X30, in particular perpendicular or orthoradially to the valve disk axis X30; and/or
the number of outputs of the housing 10 is not necessarily equal to four, but may e.g. be limited to two or be equal to three or to a number greater than four.

What is claimed is:

1. A fluid-dispensing motorized valve, including:
a housing defining an internal volume through which a fluid passes through the housing, which internal volume is connected to the outside of the housing by an inlet of the housing, through which the fluid enters the internal volume, and by at least two outlets of the housing, through which the fluid exits the internal volume,
an electric pump, which is arranged in a first sub-volume of the internal volume and which is provided with a suction, opening out into the inlet of the housing, and with a discharge, opening out into a passage of the internal volume,
a valve disk, which is arranged in a second sub-volume of the internal volume and which is movable in rotation about a valve disk axis with respect to the housing so as to control the opening-closing the at least two outlets of the housing, the first and second sub-volumes being connected directly to each other by the passage which is delimited by the housing opening out along the second sub-volume along a direction radial to the valve disk axis,
an electric actuator, which is supported by the housing and which is provided with a driving output which is rotatable about an actuator axis with respect to the housing,
a mechanical transmission system, which is supported by the housing and which connects the valve disk to the driving output in such a way that a rotation of the driving output about the actuator axis drives the valve disk in rotation about the valve disk axis, and
an electronic device, which is supported, directly or indirectly, by the housing and which is suitable for controlling the pump and the actuator, being electrically connected to the pump and to the actuator, as well as to a single connector for connection to an external source of electrical power supply, the connector being supported externally by the housing.

2. The valve according to claim 1, wherein the opening of the passage into the second sub-volume is located along the valve axis both between and spaced from opposite axial ends of the second sub-volume.

3. The valve according to claim 1, wherein the passage extends along a direction radial to the valve axis between the two opposite ends of the passage which open out into the first sub-volume and the second sub-volume, respectively.

4. The valve according to claim 1, wherein the pump and the valve disk are arranged opposite each other along a direction radial to the valve disk axis

5. The valve according to claim 1, wherein the valve axis and the actuator axis are substantially parallel to each other.

6. The valve according to claim 1,
wherein the pump and the valve disk are arranged opposite each other along a direction radial to the valve disk axis,
wherein the valve axis and the actuator axis are substantially parallel to each other, and
wherein the actuator is arranged both opposite the pump along a direction radial to the actuator axis and opposite the valve disk along a direction radial to the actuation axis.

7. The valve according to claim 1, wherein the transmission system and the electronic device are arranged in the same sealed compartment, which is delimited by the housing and a cover directly mounted on the housing.

8. The valve according to claim 1, wherein the pump, the valve disk and the actuator are arranged on a same axial side of the compartment.

9. The valve according to claim 1, wherein the transmission system includes a gear consisting of intermeshing toothed wheels which are rotatable relative to the housing about respective axes of rotation which are substantially parallel to the valve disk axis.

10. The valve according to claim 1, wherein the electronic device includes a printed circuit having an insulating support attached, directly or indirectly, to the housing.
